(19) United States
(12) Patent Application Publication
(10) Pub. No.: US 2002/0149281 A1
(43) Pub. Date: Oct. 17, 2002

(54) Stator for an electric machine

(75) Inventors: Jacques Saint-Michel, Angouleme (FR); Pascal Gauthier, Asnieres-Sur-Nouere (FR); Christophe Gilles, Angouleme (FR); Laurent Jadeau, La Rochefoucauld (FR)

Correspondence Address: OLIFF & BERRIDGE, PLC, P.O. BOX 19928, ALEXANDRIA, VA, 22320, US

(73) Assignee: MOTEURS LEROY-SOMER, ANGOULEME (FR)

(21) Appl. No.: 10/121,674

(22) Filed: Apr. 15, 2002

(30) Foreign Application Priority Data
Apr. 17, 2001 (EP) 01 400981.5
Jul. 10, 2001 (FR) 01 09180

(51) Int. Cl. H02K 3/00

(52) U.S. Cl. 310/179

(57) ABSTRACT

The present invention relates to a stator for a rotary electric machine, said stator comprising a magnetic circuit having teeth each constituting a core of a coil, and said coils are electrically connected together in such a manner as to form two independent electrical units each associated with a respective stator half.

### FIELD OF THE INVENTION

The present invention relates to rotary electric machines, and more particularly to their stators.

### OBJECTS AND SUMMARY OF THE INVENTION

A need exists to have an electric machine which can continue to operate even in the event of a fault occurring in one of its stator windings.

A need also exists to have a machine having a stator that can be made easily.

A need also exists to enable the machine to be repaired rapidly.

The invention seeks to satisfy all or some of these needs.

It achieves this by means of a novel stator for a rotary electric machine, the stator comprising a magnetic circuit having teeth each constituting the core of a coil, and wherein the coils are electrically connected together in such a manner as to form two independent electrical units each associated with a respective stator half.

By means of the invention, it is possible to make a rotary electric machine which can continue to operate under fault conditions, i.e. by powering only one of the two independent electrical units.

In particular, the invention enables a synchronous machine including a permanent-magnet rotor, in particular a flux-concentrating rotor, to continue to operate under fault conditions.

Thus, when the machine drives a refrigerating installation, for example, it is possible for said installation to continue to operate while waiting for a replacement for the faulty part.

In addition, the fact that the stator includes two independent electrical units, each associated with a respective half of the stator, significantly facilitates the manufacture of said stator since it is possible, for example, to interconnect the coils electrically before putting them into place on the stator, indeed it is possible to place the coils of each unit on a magnetic half-circuit of a stator while it is rectilinear, to interconnect them electrically, and then to curve the magnetic half-circuit in such a manner as to give it its final semi-circular shape.

The fact of having two independent electrical units, each associated with a respective stator half, also enables space to be provided between the bundles of cables associated with the two stator halves, and suitable for passing additional cables, e.g. cables connected to position sensors fixed on the teeth.

The magnetic circuit may be formed by assembling together at least two sectors; in particular, the magnetic circuit can be formed by assembling together two magnetic half-circuits.

The magnetic circuit is advantageously housed in a yoke that is separable into two halves.

By making the magnetic circuit with two magnetic half-circuits and the yoke with two half-yokes, it is possible to disassemble the stator easily into two parts, and in the event of one of the parts malfunctioning, to replace said part only, for example. In particular, the stator can be disassembled without having to disassemble the rotor.

In a particular embodiment, each electrical unit comprises coils that are connected in parallel.

The coils may be electrically connected to partially-stripped sheathed cables, and in particular they may be connected to said cables at a distance from the free ends thereof so as to retain an end piece of sheath preventing the strands of the cable from separating.

One of the electrical units may include three output cables, and the other electrical unit may include six output cables.

The stator may include at least one Hall-effect sensor fixed on a tooth, on the outlet side of the cables connected to the coils.

According to an aspect of the invention, the number of pole pairs is even. The number of poles may be equal to 8, 12, 16, or 32, for example.

The invention also provides a machine including a stator as defined above.

Such a machine may constitute a motor. The rotor may be a permanent-magnet rotor and a flux-concentrating rotor.

The machine advantageously includes control means enabling it to operate under fault conditions, using only one of the two electrical units.

The invention also provides a method of manufacturing a stator as defined above, the method comprising the following steps:

electrically interconnecting the coils of each electrical unit before mounting them on the magnetic circuit; and

mounting each coil on a tooth of a magnetic sector, and then putting said magnetic sector in place on the stator.

In particular, the coils of each electrical unit may be mounted on a magnetic half-circuit.

In an implementation of the invention, after the coils of each electrical unit have been mounted on a magnetic half-circuit, the method further comprises the step of assembling together the two magnetic half-circuits.

The coils of each electrical unit may be disposed on laminations of a magnetic half-circuit while they are rectilinear, and the laminations are curved to give them a semi-circular shape.

### BRIEF DESCRIPTION OF THE DRAWINGS

Other characteristics and advantages of the present invention will appear on reading the following detailed description of a non-limiting embodiment, and from the accompanying drawings, in which:

FIG. 1 is a diagrammatic view from above on the axis of the rotor, showing a synchronous motor including a stator of the invention;

FIG. 2 is a wiring diagram of the various coils of the stator;

FIG. 3 is an equivalent electrical circuit diagram;

FIG. 4 shows the laminations of the magnetic circuit cut to shape in such a manner as to minimize losses; and

FIG. 5 shows an electrical unit in place on the magnetic circuit of the stator.

### MORE DETAILED DESCRIPTION

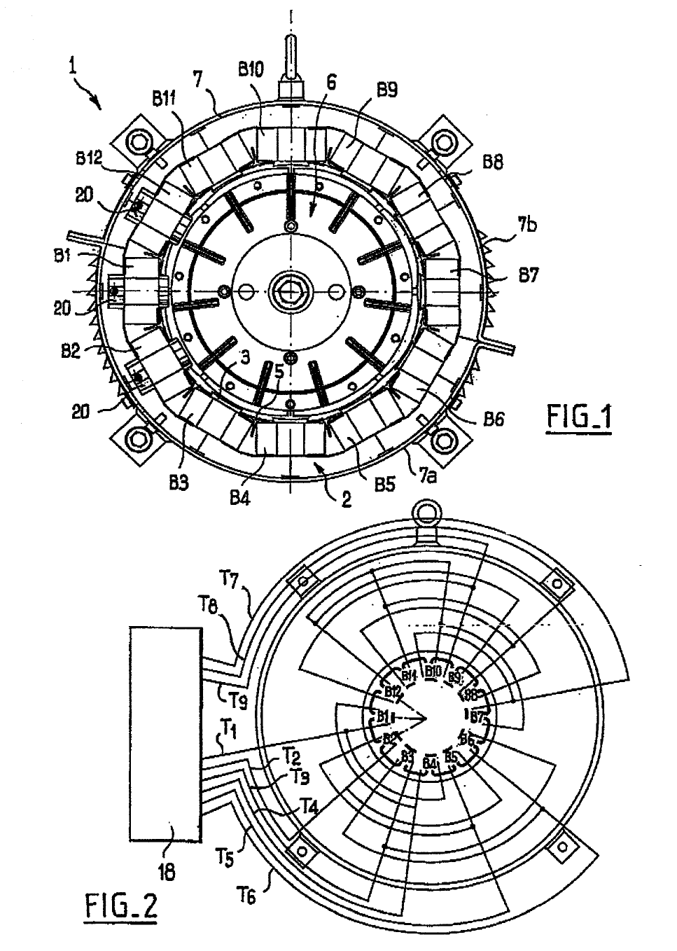

The electric machine 1 shown in part in FIG. 1 is a synchronous motor comprising a stator 2 and an inner permanent-magnet and flux-concentrating rotor 6.

The stator 2 has eight poles, the motor being designed to be powered with three-phase electricity, and it has twelve teeth 3 on which there are mounted twelve respective coils referenced B1 to B12. Each tooth 3 thus constitutes the core of a corresponding coil B1, . . . , B12. The coils are held engaged on the teeth 3 by shims 5, slid into notches 4 formed on the sides of the teeth 3.

In the example under consideration, the stator 2, as can be seen in FIG. 5 in particular, is made up of two magnetic half-circuits 2a, 2b each comprising six teeth 3. The width of the teeth (ignoring the notches 4) can be constant or else slightly tapering towards the axis of the rotor which enables the coils B1, . . . , B12 to be jammed onto the teeth 3.

The two half-stators 2a and 2b are housed in a yoke 7 formed of two half-yokes 7a and 7b assembled together by means of flanges 8.

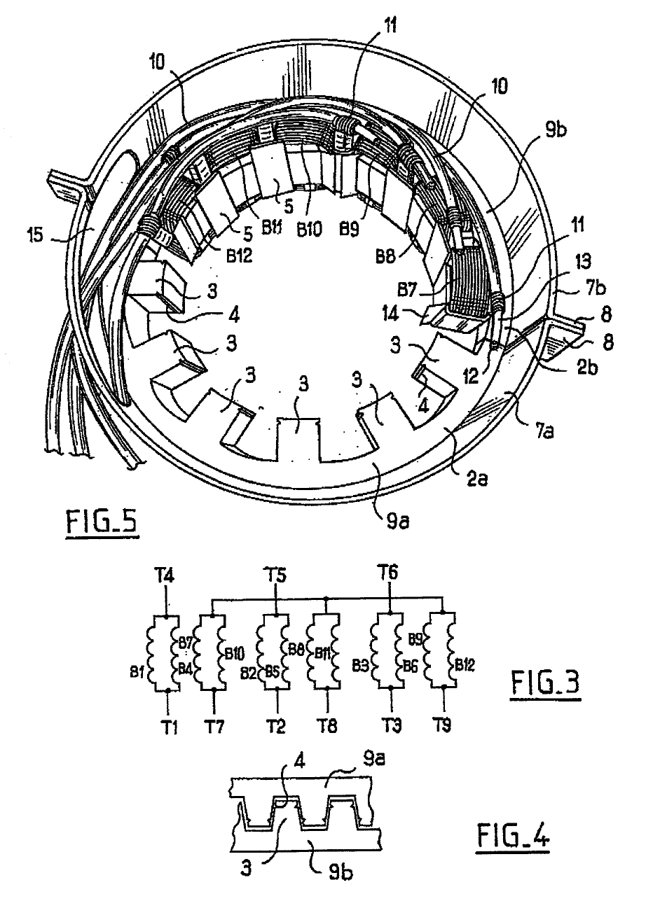

The twelve coils B1, . . . , B12 are electrically connected together by sheathed cables 10 so as to form two independent electrical units each including six coils, namely a first unit comprising the coils B1, . . . , B6 and a second unit comprising the coils B7, . . . , B12. The coils B1, . . . , B12 are interconnected in the manner shown in FIG. 2, in a configuration having two parallel paths, with the equivalent electrical circuit diagram of said configuration being given in FIG. 3.

The cables 10 are partially stripped at points where the ends 11 of the electrical conductors B1, . . . , B12 of the coils are to be soldered to the strands of the cables. It can be seen that the ends 11 of the coils B1, . . . , B12 are situated at a distance from the free ends 12 of the cables 10 so as to leave each cable 10 with a sheathed end portion, thereby preventing the strands of the cable from separating. In FIG. 5, insulating sheets 14 can be seen, that are placed between the teeth 3 and the coils while said coils are being mounted on the magnetic circuit. A slot 15 is provided through the yoke 7 for passing the cables 10.

The six cables 10 connected to the coils B1, . . . , B6 are referenced T1, . . . , T6 and the three cables 10 connected to the coils B7, . . . , B12 are referenced T7, T9. It can be seen from FIG. 3 that the coils B1 and B4 are connected in parallel and have their terminals respectively connected to the cables T1 and T4. The coils B2 and B5 are connected in parallel and have their terminals respectively connected to the cables T2 and T5. The coils B3 and B6 are connected in parallel and have their terminals respectively connected to the cables T3 and T6. The coils B7 and B10 are connected in parallel, as are the coils B8 and B11, and the coils B9 and B12, the three pairs of coils each having one set of terminals connected to a respective one of the cables T7, T8, and T9, and an opposite set of terminals all connected to a common point.

The cables T1, . . . , T9 are connected to control means 18 arranged in such a manner as to control the excitation of the coils B1, . . . , B12 so as to create a rotary magnetic field for driving the rotor.

Hall-effect sensors 20 are fixed on the teeth 3 that are associated with the coils B1, B2, and B12 respectively, and the cables connected to the sensors can easily pass through the slot 15 in the space left between the two bundles of cables T1, . . . , T6 and T7, . . . , T9.

In the embodiment described, the control means 18 are also arranged so as to enable the motor to continue to operate under fault conditions, i.e. with only one of the units B1, . . . , B6 or B7, . . . , B12. Thus, in the event of a fault occurring in one of the coils of a unit, it is possible for the motor to continue to operate by cutting off the power supply to the faulty unit.

In addition, the stator can be separated into two without having to disassemble the rotor, thereby facilitating the replacement of the faulty unit.

The stator described above is also easier to build since it is easier to make the electrical connections with the coils B1, . . . , B6 or B7, . . . , B12 of each unit before putting them into place on the teeth 3.

In addition, the magnetic circuit 9a or 9b of each half-stator 2a or 2b can be made by stacking magnetic laminations cut out in pairs while still in a rectilinear state, as shown in FIG. 4. The teeth of one lamination in a pair interfitting with the teeth of the other lamination, thereby enabling losses of scrap material to be minimized. Where necessary, the coils can be mounted on the teeth 3 before curving said laminations. In which case, the coils are preferably electrically connected to the cables 10 before the curving operation.

Naturally, the invention is not limited to the embodiment example described above.

In particular, the stator can be made with more than twelve teeth, in particular when the number of poles is equal to 12, 16, or 32, for example.

1/ A stator for a rotary electric machine, said stator comprising a magnetic circuit having teeth each constituting a core of a coil, and wherein said coils are electrically connected together in such a manner as to form two independent electrical units each associated with a respective stator half.

2/ A stator according to claim 1, wherein each unit comprises coils that are connected in parallel.

3/ A stator according to claim 1, wherein the magnetic circuit is formed by assembling together at least two sectors.

4/ A stator according to claim 3, wherein the magnetic circuit is formed by assembling together two magnetic half-circuits.

5/ A stator according to claim 1, wherein the magnetic circuit is housed in a yoke that is separable into two halves.

6/ A stator according to claim 1, wherein said coils are electrically connected to partially-stripped sheathed cables.

7/ A stator according to claim 6, wherein said cables having free ends, said coils are connected to said cables at a distance from the free ends thereof.

8/ A stator according to claim 1, wherein one of the units includes three output cables, and the other unit includes six output cables.

9/ A stator according to claim ¹, including at least one Hall-effect sensor fixed on a tooth, on the outlet side of said cables connected to said coils.

10/ A stator according to claim 1, wherein the number of pole pairs is even.

11/ A stator according to claim 1, wherein the number of poles is equal to 8, 12, 16, or 32.

12/ A machine including a stator as defined in claim 1.

13/ A machine according to claim 12, said machine constituting a motor.

14/ A machine according to claim 12, said machine comprising a rotor, wherein said rotor is a permanent-magnet rotor and a flux-concentrating rotor.

15/ A machine according to claim 12, including control means enabling it to operate under fault conditions, using only one of the two units.

16/ A method of manufacturing a stator as defined in claim 1, the method comprising one of the following steps:
electrically interconnecting the coils of each unit before mounting them on said magnetic circuit;
mounting each coil on a tooth of a magnetic sector, and then putting said magnetic sector in place on said stator.

17/ A method according to claim 16, wherein said coils of each unit are mounted on a magnetic half-circuit.

18/ A method according to claim 16, wherein, after said coils of each unit have been mounted on a magnetic half-circuit, it further comprises the step of assembling together said two magnetic half-circuits.

19/ A method according to claim 16, wherein said coils of each unit are disposed on laminations of a magnetic half-circuit while they are rectilinear, and wherein the laminations are curved to give them a semi-circular shape.
